(19) United States
(12) Patent Application Publication
(10) Pub. No.: US 2016/0259949 A1
(43) Pub. Date: Sep. 8, 2016

(54) SYSTEM AND INTERFACE SUPPORTING SAFE SHARING OF CONTENT ON SOCIAL MEDIA SERVICES

(71) Applicant: Cocoon Data Holdings Limited, Sydney (AU)

(72) Inventors: William Stroud, McLean, VA (US); Trent Telford, Reston, VA (US); Powell Benedict, III, Purcellville, VA (US)

(21) Appl. No.: 15/044,076

(22) Filed: Feb. 15, 2016

Related U.S. Application Data
(60) Provisional application No. 62/127,507, filed on Mar. 3, 2015.

(51) Int. Cl. G06F 21/62; G06F 21/60; H04L 29/06

(52) U.S. Cl. CPC G06F 21/6218; H04L 63/102; G06F 21/602

(57) ABSTRACT

A framework for sharing protected content includes a safe service comprising an access service and a content service; and a safe access service application integrated with at least one social media service application, said safe access service application constructed and adapted to provide controlled access to protected content stored in the content service, said controlled access being via a user interface (UI) of the at least one social media service application.

### RELATED APPLICATION

This application is related to and claims priority from co-owned U.S. Provisional Patent Application No. 62/127,507, filed Mar. 3, 2015, the entire contents of which are hereby fully incorporated herein by reference for all purposes.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to safe sharing of content on social media services.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of aspects of a framework supporting safe sharing of content on a social media service in accordance with exemplary embodiments hereof;

FIGS. 2-5 show aspects of various exemplary interactions of the framework of FIG. 1; and

FIG. 6 depicts aspects of computing and computer devices in accordance with exemplary embodiments hereof

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

API means application programming interface;

GUI means graphical user interface;

SMS means social media service (and, unless otherwise specially stated, does not refer to short message (or messaging) service);

SNS means social networking service; and

UI means user interface.

As used herein, the term “mechanism” refers to any device(s), process(es), service(s), or combination thereof A mechanism may be implemented in hardware, software, firmware, using a special-purpose device, or any combination thereof A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

As used herein the terms “social networking service” (“SNS”) and/or “social media service” (SMS) are used synonymously to refer, without limitation, to any kind of online networking service that supports interaction and exchange of data between registered users of that service. Non-limiting examples of social networking/media services include Facebook, Twitter, LinkedIn, MySpace, Google Pages, etc. As is known, an SNS may offer a web-based interface for use on any general-purpose computer system as well as a particular application (“app”) for use on a particular platform such as a smartphone or the like (e.g., an iPhone or Android). It should be appreciated that the system is not limited by the particular features offered by each SNS or by the manner(s) in which these features are offered. It should further be appreciated that the system is not limited by the manner in which an SMS's users register with the SMS or by the SMS's requirements, if any, for proof of a user's identity.

### Background and Overview

SMS use is widespread among computer users, especially on the Internet, and it has become one of the more predominant ways by which Internet users communicate. Many SMS systems provide some means for their users to communicate within as well as outside of the SMS. For example, Facebook provides a so-called “chat” feature to allow real-time messaging between its users.

Essentially, in some aspects, an SMS is a communications system whereby its users can selectively communicate and share information, all while under the supervision and control of the SMS. As used herein the term “communicate” refers to any kind of communication, including email, chatting, messaging, texting, etc. It should also be appreciated that, as used herein, the term “information” refers to any kind of information, in any form, and the system is not limited by the kind of information communicated or by the underlying form that information takes. E.g., without limitation, information may be in the form of one or more of text, audio, images, video, etc. A particular item of information may be stored in one or more files using/encoded with whatever format and/or protocol is appropriate for that item. For example, an image may be stored in a file and encoded using a JPEG protocol. As another example, a document may have been generated using a word processor such as Microsoft Word or the like and may then be stored as a PDF file.

The inventors have realized that while, for many Internet users, an SMS is their primary means of communication, little or no regard has been given to secure communication or exchange of information.

It is therefore desirable, and an object of this invention, to provide a means for secure communication or exchange of information via an SMS.

Overview—Structure

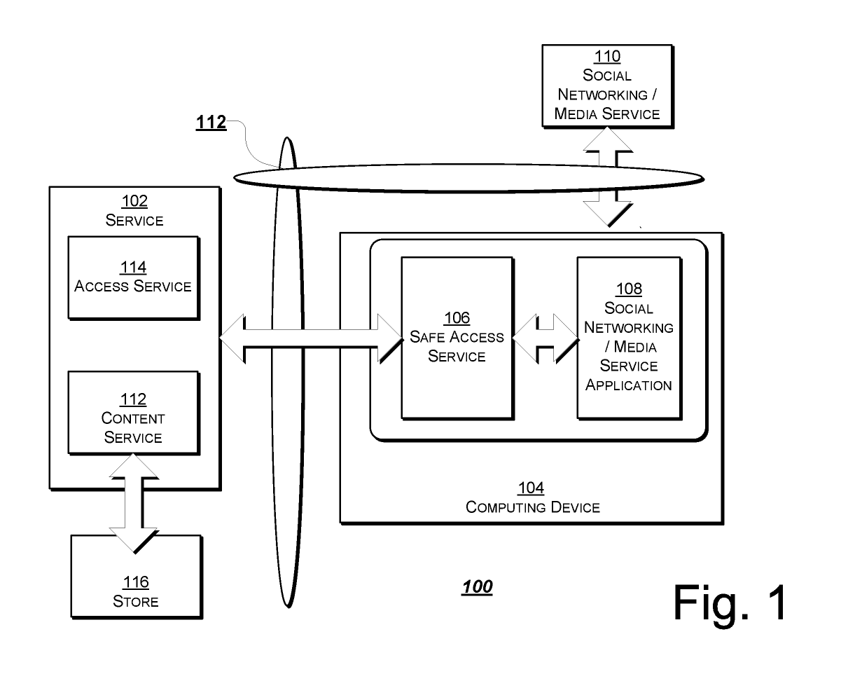

FIG. 1 shows an overview of aspects of a framework 100 supporting safe sharing of content on a social media service in accordance with exemplary embodiments hereof. The framework 100 includes one or more safe services 102 accessible from a user's computing device 104 via a safe access application 106. The safe access application 106 is mechanism operable on users' computing devices, and interacting with one or more social networking/media service applications 108 on the user's computing device. Preferably the safe access application 106 is a plugin or app integrated with a social networking/media service applications 108, e.g., via an API or the like. For example, in some embodiments hereof, safe access application 106 may be an app integrated with Facebook or LinkedIn or Twitter. It should be understood and appreciated that the safe access 106 will need to interface with each social networking/media service applications 108 in an appropriate manner, typically as defined by the (public) API of that SMS.

The social networking/media service application(s) 108 interact with a corresponding social networking/media service 110, typically via a network 112 (e.g., the Internet). The system is not limited by the manner in which the social networking/media service application(s) 108 interact with a corresponding social networking/media service 110.

The safe access application/mechanism 106 communicates with the safe service 102 as described herein, preferably also via the network 112 (e.g., the Internet).

Each user of the social networking/media service 110 is registered with that service and has some form of uniquely identifying credential issued or used by that service. Typically a user has to login to the social networking/media service in order to use it, and the user's login typically requires some form of authentication (e.g., a username and password). It should be appreciated that the system is not limited by the manner or type or strength of authentication used or required by the social networking/media service 110, other than to assume that users can be distinguished within the social networking/media service 110 by some form of uniquely identifying credential.

As further shown in FIG. 1, the safe service 102 includes at least one content service 112 and at least one access service 114. The content service 112 is operably connected to a store 116. The safe service 102, via, content service 112, preferably stores data in the store 116 in an encrypted form. In some embodiments hereof, the store 116 is an S3 compatible cloud object store, using AWS S3 as default object store.

The safe service 102 requires unique identification of each user and preferably requires user authentication. Preferably the safe service 102 uses a credential that is the same as (or derivable from) the user's SMS credential.

Encryption

As is well known, encryption of data uses so-called keys. An important feature of the present architecture is that the keys and the data are always stored separately.

While any encryption techniques may be used, preferred embodiments hereof implement the FIPS-197 standard Advanced Encryption Standard (AES) with 256-bit key sizes (AES-256) for cryptography. These keys are used with a cryptographic algorithm to encrypt and decrypt data.

Each of the applications 110 is essentially a mechanism (as defined above) that may provide one or more services via an appropriate interface. Although shown as separate mechanisms for the sake of this description, it should be appreciated that some or all of the various applications 110 may be combined. The various applications (mechanisms) 110 may be implemented in any manner and need not all be implemented in the same manner (e.g., with the same languages or interfaces or protocols).

The access service 114 is responsible for handling user authentication and authorization, key management, rights management, metadata management, and maintaining audit records. The access service 114 should never touch the actual data content (unencrypted or encrypted data), creating the appropriate separation of concerns between the data and the keys.

The content service 112 preferably handles all aspects of storing the encrypted data in store 116, including: (i) the upload and download of encrypted files; (ii) server-side cryptography, when used, e.g., by a web application; and (iii) integration with storage providers.

The access service 114 may also use a database (not shown) to store information such as access control details (described in greater detail below), cryptographic keys and audit data. This database can be configured for high availability and fault tolerance.

Access Control

A safe service user may have one or more roles with respect to a particular item of data, and the access service 114 enforces access control of data based on a user's role with respect to that data. In some implementations a user's roles may be administrator, originator, collaborator, or ad hoc user. As used herein, a user with the role of administrator is referred to as an Administrator; a user with the role of originator with respect to particular content is referred to as an Originator for that content; a user with the role of collaborator with respect to particular content is referred to as a Collaborator for that content.

An Originator (i.e., a user with the role of originator with respect to particular content) may create secured content (e.g., files) using the safe service 102 and share that secured content with users who are collaborators or with ad hoc users (i.e., users who are not yet registered on the system).

A Collaborator and an Ad hoc user can access and decrypt secured content (e.g., files) that has been shared with them. Originators implicitly inherit a Collaborator role for content for which they have the role of originator.

In preferred embodiments hereof, the safe service 102 may offer a finer level of access controls that can be applied to individual secured content (e.g., files), such as, for example, and without limitation:
Grant and revoke access to individual Collaborators;
Define the level of access (e.g., download or view only);
Restrict copy/paste against the view only data;
Define and enforce print/no print access to view only data;
Define and enforce a time period (e.g., a date period) when the secured data can be accessed (or decrypted);
Define and enforce a maximum number of times that the secured data can be accessed (or decrypted);
Define and enforce a location or area (e.g., via a polygon of geographic co-ordinates) within which secured data can or cannot be decrypted accessed (or decrypted).

It should be appreciated that more than one access control or rule may apply to particular data, and so secured data may be shared with a Collaborator or with an Ad hoc user, that user cannot access the secure data until the conditions defined by all access controls applied to it (by its Originator) have been met.

When a user is authorized by the access service 114 to access a certain secure data item, the access service 114 provides the user with a cryptographic key required to decrypt the associated data.

In some embodiments hereof an Originator may also add metadata (e.g., as key-value pairs) to secured data. This metadata may be stored in the Access Service's database (e.g., linked to the secured data's record). Preferably metadata can only be accessed after an authenticated user has been successfully authorized by the Access Service.

Originators can apply access controls to their data, controlling how it can be consumed by the Collaborators. These controls may include restricting to view-only, disabling print, copy/paste and access granted against a set time/date. An Originator (or authorized administrator) may revoke the access rights of Collaborators or to any protected file at any time. Revocation is preferably reflected in real-time and applies to all subsequent access attempts.

Auditing and Reporting

The access service 114 preferably maintains audit information for all transactions that are conducted by the safe service 102, including, for example, and without limitation:
The identity of and time when a user accessed a resource.
The user's IP address and the client ID of the application that was used.
Whether or not the event completed successfully, thereby recording authorized and unauthorized attempts to access.

This information may be stored in the database and logs. In preferred embodiments hereof, the access service 114 only issues cryptographic keys and grants resources once audit information has been stored in the database.

Users' Devices

Users may access the framework 100 using any kind of computing device, including mobile devices (e.g., phones, tablets, etc.), computers (e.g., desktops, laptops, etc.), and the like. Computing devices are described in greater detail below. Some or all of the components that make up a device may be integrated into a single physical device or appliance (e.g., a laptop computer), or they may all be separate components (e.g., a desktop computer). As another example, a device may be integrated into a television or a set-top box or the like.

Exemplary Implementation & Operation

Clients (users' devices) interact with the system 100 via an appropriate interface. These interactions preferably take place using a user interface (UI) application running on each client.

The system 100, preferably via a GUI on the SMS system, supports these access methods:
Upload
Share
Download
Shred

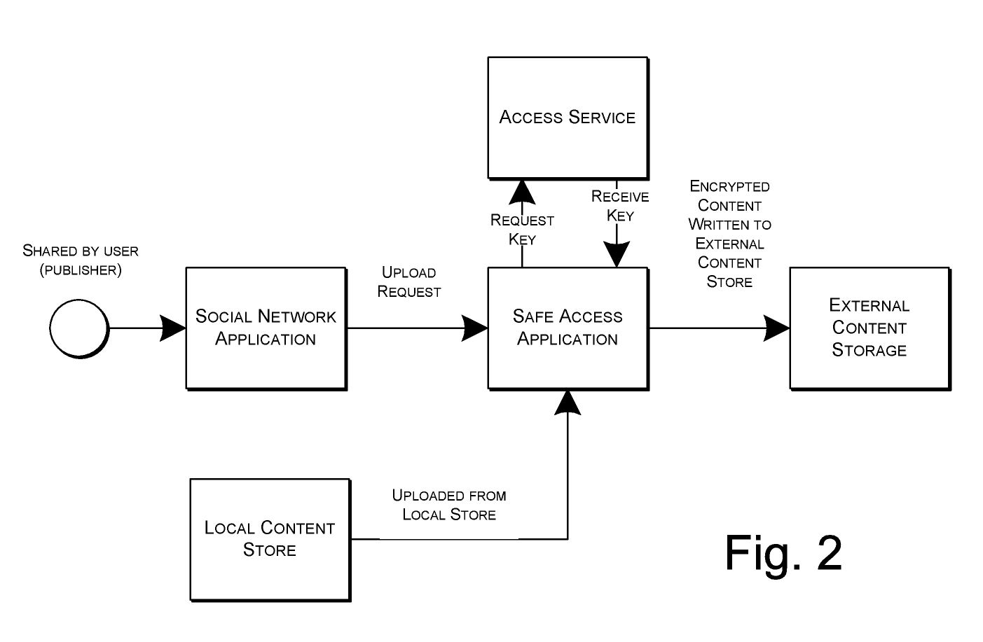

FIGS. 2-5 show aspects of various exemplary interactions of the framework 100 of FIG. 1.

Upload

FIG. 2 shows an example of an upload function with the system 100 according to exemplary embodiments hereof As shown in FIG. 2, when a user (A) wants to upload content (e.g., a locally stored file) to the system, the user A makes an upload request using the safe access service (106 in FIG. 1) via the social network application (108 in FIG. 1). The upload request may be made using the GUI of the safe access service integrated into the GUI of the social network application. In response to the upload request, the safe access service 106 requests a key from the access service and, assuming that the user (A) is properly authorized and authenticated, obtains the required key from the access service. The safe access service 106 obtains and uploads the content (e.g., the locally stored file) and writes it (in encrypted form, using the keys obtained) via the safe service 102 to external content storage (e.g., store 116).

When a user uploads content (e.g., a file), the access service 102 handles the encryption and key management, placing a protected (e.g., encrypted) version of the content into the store 116. The uploaded content may appear in a list of protected content ready to be shared by user A. The keys are not stored with the protected content and access to the keys is controlled in accordance with access rules set by the uploader.

The access service preferably uses the user's social network credentials as login credentials.

Share

Once content is uploaded (as described above), User A (also referred to here as the Originator) can now share the protected content by specifying authorized users (Collaborators) with permitted access and usage controls. The Originator can express specific conditions that must be met for a Collaborator to access the protected file, such as, e.g., restricting access to view-only, disabling print and copy/paste within the application and granting access against a set time/date. The safe service 102 then advises the Collaborators, via their respective social networking applications, that protected content has been shared with them.

It should be appreciated that an Originator may, themselves, be sharing content that was shared with them (if so permitted by the access and usage controls), and so the role of Originator is not static and does not imply that the person is the first and only originator of any particular content. For example, if user A shares with user B and then user B shares with a third user (C), then user A is the Originator for the share with user B (and user B is a Collaborator for that share); and user B is the Originator for the share with user C (and user C is a Collaborator for that share).

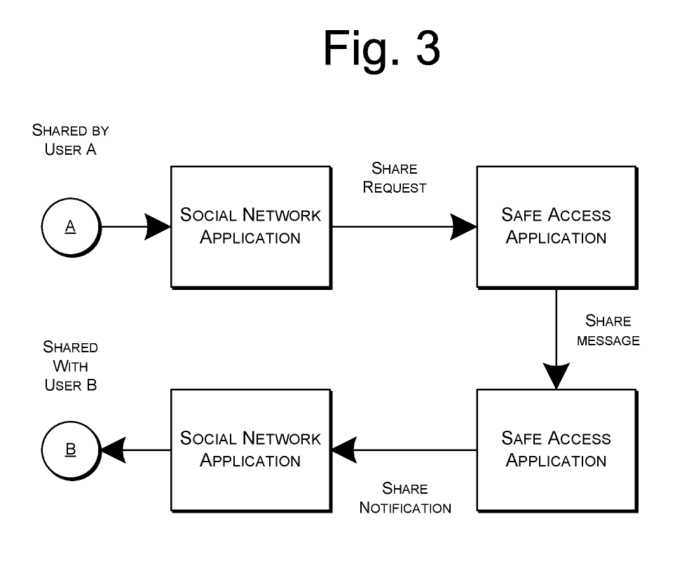

FIG. 3 shows an example of a share function with the system 100 according to exemplary embodiments hereof As shown in FIG. 3, when a user (A) wants to share previously uploaded content with one or more other users, the user (A) makes a share request using the safe access service (106 in FIG. 1) via the social network application (108 in FIG. 1). The share request results in a share message being sent to user B′s safe access application which, in turn, provides a share notification to user B via user B′s social network application.

When a user is given access to protected content they are given controlled access to the key(s) required to decrypt the content, and access to the content is within and under the control of the safe service 102.

Download

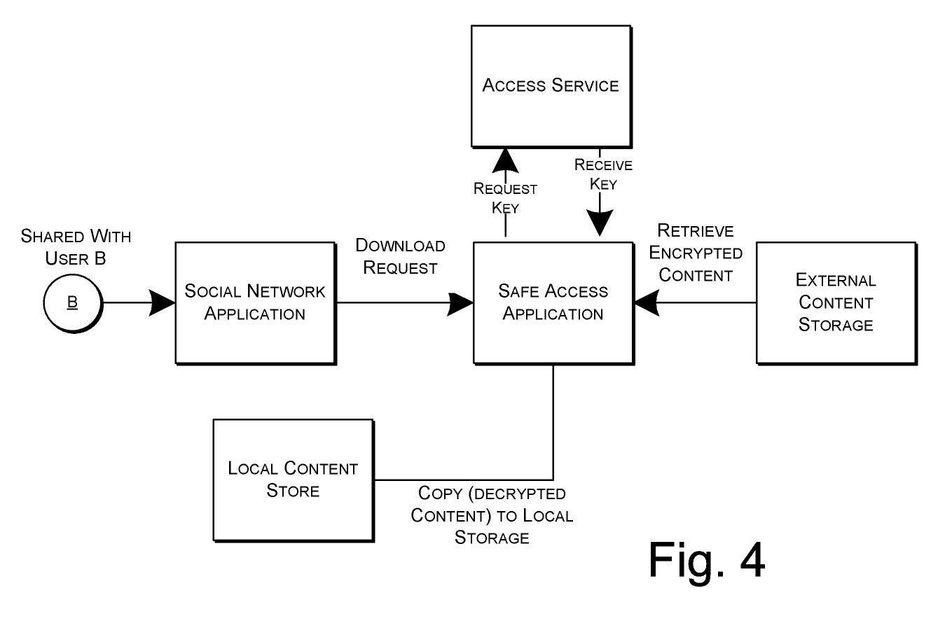

FIG. 4 shows an example of a download function with the system 100 according to exemplary embodiments hereof When a user shares protected content with other users, those other users may access the content (as Collaborators) in accordance with the access and usage controls set by the content sharer or Originator. These access and usage controls are enforced by the safe service 102.

When a user (B) has had protected content shared with them (by a Originator), then that user B may download the protected content (in accordance with the access and usage controls set by the Originator). User B makes a download request using the safe access service (106 in FIG. 1) via their social network application (108 in FIG. 1). The download request may be made using the GUI of the safe access service integrated into the GUI of the social network application. In response to the download request the safe access service 106 requests and obtains the required key(s) from the access service (again, assuming the user's credentials are appropriately authenticated). The safe access service 106 then retrieves and uploads the protected (e.g., encrypted) content from the external storage (e.g., store 116) and copies the protected content via the safe service 102 to local storage.

Note that if user B is not allowed to store a local unprotected copy of the content then the safe access service 106 on user B's device will not allow the download. In some cases a user may be permitted to view or otherwise render protected content. In such cases the user's safe access service 106 will render the content within the UI of the social networking application 108. As used herein the term “render” means to produce the corresponding content in an appropriate form and/or manner For example, an image or text or video may be rendered by being displayed on a monitor of the user's computing device, whereas audio content may be rendered by being played through a speaker associated with the user's computing device.

The safe access service 106 preferably controls and limits rendering of protected content within the UI provided by the social networking application 108, so that preferably no protected content is rendered in unprotected form outside of the control of the safe access service.

Shred

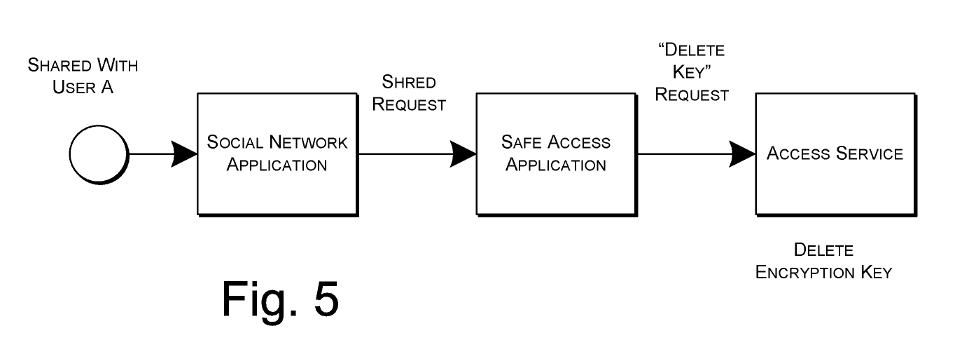

FIG. 5 shows an example of a shred function with the system 100 according to exemplary embodiments hereof. A shred function is similar to a delete function except that the actual protected content may not be deleted. Instead, the keys needed to decrypt the content may be deleted (or themselves made inaccessible) so that, effectively, the protected content cannot be accessed in an unprotected form. Thus, as shown in the drawing in FIG. 5, a shred request made by a user to the safe access application results in the safe access application making a “delete key” request of the access service which, in turn, deletes the encryption key.

Credentials

The safe service 102 requires registration and credentials for use. In preferred embodiments hereof the safe service 102 uses a user's social media service credentials (e.g., their Facebook login), so that the user is not required to have a separate login for the safe service. When the user accesses the safe service 102 via a safe access service 106 that is integrated (e.g., as an app) with their social networking application 108, the safe access service 106 will use that user's social networking credentials to login to and use the safe service 102.

### Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

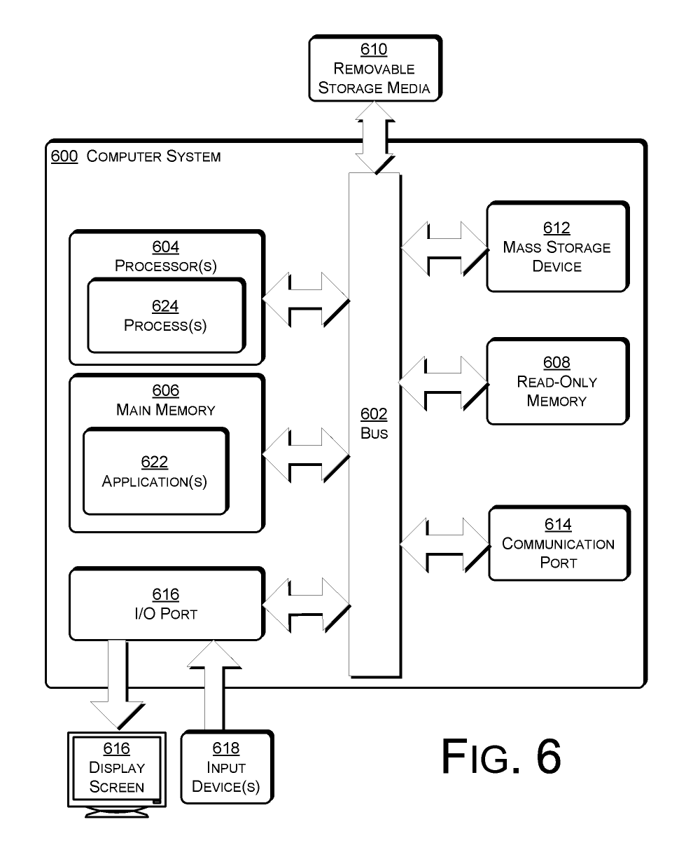

FIG. 6 is a schematic diagram of a computer system 600 upon which embodiments of the present disclosure may be implemented and carried out.

According to the present example, the computer system 600 includes a bus 602 (i.e., interconnect), one or more processors 604, one or more communications ports 614, a main memory 606, removable storage media 610, read-only memory 608, and a mass storage 612. Communication port(s) 614 may be connected to one or more networks by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an RS-232 port for use with a modem based dial-up connection, a 10/100 Ethernet port, a Gigabit port using copper or fiber, or a USB port, and the like. Communications port(s) 614 may be chosen depending on a network such as a Local Area Network (LAN), a Wide Area Network (WAN), a CDN, or any network to which the computer system 600 connects. The computer system 600 may be in communication with peripheral devices (e.g., display screen 616, input device(s) 618) via Input/Output (I/O) port 620. Some or all of the peripheral devices may be integrated into the computer system 600, and the input device(s) 618 may be integrated into the display screen 616 (e.g., in the case of a touch screen).

Main memory 606 can be Random Access Memory (RAM), or any other dynamic storage device(s) commonly known in the art. Read-only memory 608 can be any static storage device(s) such as Programmable Read-Only Memory (PROM) chips for storing static information such as instructions for processor(s) 604. Mass storage 612 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 602 communicatively couples processor(s) 604 with the other memory, storage and communications blocks. Bus 602 can be a PCI/PCI-X, SCSI, a Universal Serial Bus (USB) based system bus (or other) depending on the storage devices used, and the like. Removable storage media 610 can be any kind of external hard-drives, floppy drives, IOMEGA® Zip Drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 606 is encoded with application(s) 622 that support(s) the functionality as discussed herein (an application 622 may be an application that provides some or all of the functionality of one or more of the mechanisms described herein). Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service(s) or mechanism(s) related to the application(s). In other words, the process(es) 624 represents one or more portions of the application(s) 622 performing within or upon the processor(s) 604 in the computer system 600.

It should be noted that, in addition to the process(es) 624 that carries(carry) out operations as discussed herein, other embodiments herein include the application 622 itself (i.e., the un-executed or non-performing logic instructions and/or data). The application 622 may be stored on a computer readable medium (e.g., a repository) such as a disk or in an optical medium. According to other embodiments, the application 622 can also be stored in a memory type system such as in firmware, read only memory (ROM), or, as in this example, as executable code within the main memory 606 (e.g., within Random Access Memory or RAM). For example, application 622 may also be stored in removable storage media 610, read-only memory 608, and/or mass storage device 612.

Those skilled in the art will understand that the computer system 600 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

We claim:

1. A framework for sharing protected content, the framework comprising:
(A) a safe service comprising an access service and a content service; and
(B) a safe access service application integrated with at least one social media service application, said safe access service application constructed and adapted to provide controlled access to protected content stored in the content service, said controlled access being via a user interface (UI) of the at least one social media service application.

2. The framework of claim 1 wherein said controlled access comprises one or more of:
granting and revoking access to individual collaborators;
defining a level of access.

3. The framework of claim 1 wherein the safe access service maintains audit information for transactions conducted by the safe access service.

4. The framework of claim 3 wherein said audit information comprises one or more of:
an identity of and time when a user accessed a resource;
a user's IP address and a client identity of the application that was used; and
whether or not the event completed successfully.

5. The framework of claim 1 wherein, via a GUI on the at least one social media service application, the framework supports upload, share, download, and shred access methods.

6. The framework of claim 5 wherein,
(C) in response to a request by a first user to upload content, the safe service:
(C)(1) requests, and, if the first user is authorized and authenticated, obtains one or more keys from an access service; and
(C)(2) obtains the content and writes the content as protected content, in encrypted form, to external content storage, using the one or more keys obtained via the safe service, wherein the one or more keys are not stored with the protected content and wherein access to the one or more keys is controlled in accordance with access rules set by the first user.

7. The framework of claim 6 wherein
said first user makes a share request to share previously uploaded content using the safe access service via the social media service application, said share request resulting in a share message being sent to at least one second user's safe access application;
said at least one second user's safe access application provides a share notification to said at least one second user via said at least one second user's social media service application, wherein, when said at least one second user is given controlled access to one or more keys required to decrypt the protected content, and wherein access to the content is within and under the control of the safe service.

8. The framework of claim 7, wherein, when a second user has had protected content shared with them by an originator, then said second user may download the protected content in accordance with the access and usage controls set an originator.

9. The framework of claim 8 wherein said second user makes a download request using the safe access service via said second social media service application, wherein said download request is made using the UI of the safe access service integrated into the UI of the social media service application, and wherein,
in response to the download request the safe access service requests and obtains one or more required keys from the access service, and then the safe access service retrieves and uploads the protected content from external storage and copies the protected content via the safe service to local storage.

10. The framework of claim 9 wherein, in response to a request to shred protected content, one or more keys needed to decrypt the protected content are deleted or made inaccessible.
